(19) United States
(12) Patent Application Publication
(10) Pub. No.: US 2008/0134270 A1
(43) Pub. Date: Jun. 5, 2008

(54) Programming Management System, Programming Management Apparatus, Programming Management Method, and Programming Management Program

(76) Inventors: Kazutomo Watanabe, Saitama (JP); Masao Higuchi, Saitama (JP); Ryuichiro Morioka, Saitama (JP); Gaku Yamamura, Tokyo (JP)

Correspondence Address: LADAS & PARRY, 5670 WILSHIRE BOULEVARD, SUITE 2100, LOS ANGELES, CA, 90036-5679, US

(21) Appl. No.: 11/665,939

(22) PCT Filed: Oct. 3, 2005
(86) PCT No.: PCT/JP05/18279

§ 371 Date: Aug. 24, 2007

(30) Foreign Application Priority Data
Oct. 20, 2004 (JP) 2004-305958

(51) Int. Cl. H04N 7/173

(52) U.S. Cl. 725/118

(57) ABSTRACT

The present invention is directed to provide a programming management system enabling the user to certainly recognize a programming conflict state and capable of avoiding the conflict state for the user.

The programming management system is a system in which a plurality of programming management apparatuses 2 and 3 for managing programming information for programming an operation of devices 4 and 5 and the devices 4 and 5 are connected to each other via a network 1. The system includes: detecting means for detecting that at least two programming management apparatuses 2 and 3 are connected to each other via the network 1; determining means for determining the presence or absence of a conflict between the programming information registered in the programming management apparatuses 2 and 3 at the time of the detection; and notifying means, when occurrence of the conflict in two pieces of the programming information is detected, for notifying the user of the occurrence of the conflict.

### TECHNICAL FIELD

The present invention relates to the technical field of a programming management system, a programming management apparatus, a programming management method, a programming management program, and the like for managing schedule of recordings or the like by using a device connected via a network.

### BACKGROUND ART

Hitherto, Patent documents 1 to 4 disclose inventions related to programming management. In a recording programming method disclosed in Patent document 1, a notification of a recording programming state of a recorder is received, a request for setting programming made from a remote terminal is received, and a check is made to see consistency (conflict state) of the programming state in the recorder with the programming setting request from the terminal. In the case where the programming setting request cannot be accepted (in the case where there is no consistency), warning is notified to the terminal.

Therefore, the recording programming method disclosed in Patent document 1 checks the consistency of recordings at the time of registering programming from the remote terminal. When there is no consistency, it is notified to the terminal side.

A program programming system disclosed in Patent document 2 is a system having a plurality of broadcast receivers and a programming controller. The system includes: connecting means for communicatably connecting each of the plurality of broadcast receivers and the programming controller to each other; notifying means, when a conflict occurs in programmed recording of programs in a first broadcast receiver of the plurality of broadcast receivers, notifying the programming controller of programming information regarding the programmed recording of programs via the connecting means; and programming means for programming a program on the basis of the programming information via the connecting means in one of the plurality of broadcast receivers except for the first broadcast receiver.

Therefore, in the program programming system disclosed in Patent document 2, when programmed recordings conflict, the conflict is notified to the programming controller or the user.

A recording programming management apparatus disclosed in Patent document 3 has information display means, when two pieces of programming information overlap, for displaying the two pieces of programming information. By using the information display means, an instruction of selecting one of the two pieces of programming information is received from the operator of the recording programming management apparatus body.

Therefore, when entered program programming information overlaps, the recording programming management apparatus disclosed in Patent document 3 displays the overlapped programming information.

According to the inventions disclosed in Patent documents 1 to 3, on registration of programming or on reception of programming information from a device such as a broadcast receiver, an apparatus for managing programming makes a check of a conflict with already registered program and, when a conflict (overlap) is detected, notifies the user or the like of the fact. In the inventions disclosed in Patent documents 1 to 3, the conflict check process is started by using, as a trigger, registration of programming or reception of programming information.

A broadcast program recording/reproducing system disclosed in Patent document 4 registers programming information of a device into a bulletin board sub-unit, enables the programming information to be recognized by data transmission/reception on a bus conformed with IEEE 1394 standard (formal name is “IEEE Std. 1394-1995 IEEE Standard for a High Performance Serial Bus”), and notifies of whether or not programming can be set in a target device as the above-described device.

According to the invention disclosed in Patent document 4, a device itself used for programming notifies of whether programming can be set or not at a predetermined timing.

Patent document 1: Japanese Unexamined Patent Application Publication (JP-A) No. 2002-158951
Patent document 2: JP-A No. 2001-333337
Patent document 3: JP-A No. H11-136615
Patent document 4: JP-A No. 2002-51284

### DISCLOSURE OF THE INVENTION

### Problems to be Solved by the Invention

In the inventions disclosed in Patent documents 1 to 3, a conflict check is made on registration of programming information. However, when the configuration of the programming management apparatus on a network or a device used for programming changes, for example, a conflict check when the programming management apparatus or the device used for programming is disconnected from the network is not made. Consequently, programming information is transmitted/received among the programming management apparatuses at the time of registering the programming information. When it is found that programming information conflicts with registered programming, a notification of the conflict is sent to the user.

In the inventions disclosed in Patent documents 1 to 3, however, there is the possibility that a first programming management apparatus in which certain programming information is registered is disconnected from the network and, during the first programming management apparatus is out of the network, programming information conflicting with the first programming management apparatus is registered in a second programming management apparatus. In this case, the first and second programming management apparatuses are not connected to each other via the network, a conflict check between them cannot be made. Further, in the case where the first programming management apparatus is connected to the network again in this state, a problem occurs such that, in spite of the fact that a conflict occurs in the system as a whole on the network, the user cannot recognizes the fact.

In the invention disclosed in Patent document 4, when the device is connected to the network, the programming management apparatus does not check programming information registered in the device. Specifically, in the invention disclosed in Patent document 4, a bulletin board subunit is mounted on a device, and programming information using the device is registered by the programming management apparatus. There is the possibility that another device registers programming information overlapping the programming information registered in the device in a state where the programming management apparatus and the device are not connected to each other via the network.

The bulletin board subunit in disclosed in Patent document 4 has only the programming bulletin board function. In the standard, the bulletin board subunit does not hinder writing of programming information conflicting (overlapping) each other, and it is not specified that the bulletin board subunit itself makes a confliction check. Also in the case where the programming management apparatus and the device are connected again to the network in such a situation, the programming conflict check is not made. A problem occurs such that although a conflict state occurs in the whole system on the network, the user does not recognize the fact.

The present invention has been achieved in consideration of the circumstances. An object of the invention is to provide a programming management system, a programming management apparatus, a programming management method, and a programming management program enabling the user to certainly recognize a programming conflict state and capable of avoiding the conflict state for the user.

### Means for Solving the Problems

In order to solve the above problems, the invention according to claim 1 relates to a programming management system in which a plurality of programming management apparatuses for managing programming information for programming an operation of a device and the device are connected to each other via a network, comprising:

detecting means for detecting that at least two programming management apparatuses are connected to each other via the network;

determining means for determining the presence or absence of a conflict between the programming information registered in the programming management apparatuses at the time of the detection; and

notifying means, when occurrence of the conflict in two pieces of the programming information is detected, for notifying a user of the occurrence of the conflict.

In order to solve the above problems, the invention according to claim 2 relates to a programming management system in which a device capable of registering programming information for programming an operation of the device and a programming management apparatus capable of managing the programming information registered in the device and registering the programming information are connected to each other via a network, comprising:

detecting means for detecting that the programming management apparatus and the device are connected to each other via the network;

determining means for determining the presence or absence of a conflict between the programming information registered in the programming management apparatus and the device at the time of the detection; and

notifying means, when occurrence of the conflict in the programming information is detected, for notifying the user of the occurrence of the conflict.

In order to solve the above problems, the invention according to claim 4 relates to a programming management apparatus connected, via a network, to a plurality of devices each capable of registering programming information for programming an operation of the device, and for managing the programming information, comprising:

detecting means for detecting connection of each of the devices via the network;

determining means for determining the presence or absence of a conflict between the programming information registered in the devices at the time of the detection; and

notifying means, when occurrence of the conflict in the programming information is detected, for notifying the user of the occurrence of the conflict.

In order to solve the above problems, the invention according to claim 5 relates to a programming management apparatus connected to a device via a network, and for managing programming information for programming an operation of the device, comprising:

detecting means for detecting connection to another programming management apparatus via the network;

determining means for determining the presence or absence of a conflict between the programming information registered in the apparatus itself and the another programming management apparatus at the time of detection; and

notifying means, when occurrence of the conflict in two pieces of the programming information is detected, for notifying the user of the occurrence of the conflict.

In order to solve the above problems, the invention according to claim 7 relates to a programming management method, in which a plurality of programming management apparatuses for managing programming information for programming an operation of a device and the device are connected to each other via a network, comprising:

a detecting process of detecting that at least two programming management apparatuses are connected to each other via the network;

a determining process of determining the presence or absence of a conflict between the programming information registered in the programming management apparatuses at the time of the detection; and

a notifying process, when occurrence of the conflict in two pieces of the programming information is detected, of notifying the user of the occurrence of the conflict.

In order to solve the above problems, the invention according to claim 8 relates to a programming management method, in which a device capable of registering programming information for programming an operation of the device and a programming management apparatus capable of managing the programming information registered in the device and registering the programming information are connected to each other via a network, comprising:

a detecting process of detecting that the programming management apparatus and the device are connected to each other via the network;

a determining process of determining the presence or absence of a conflict between the programming information registered in the programming management apparatus and the device at the time of the detection; and

a notifying process, when occurrence of the conflict in the programming information is detected, of notifying the user of the occurrence of the conflict.

In order to solve the above problems, the invention according to claim 9 relates to a programming management method for managing programming information for programming an operation of a device, the programming information being able to be registered in a plurality of devices connected via a network, comprising:

a detecting process of detecting connection of each of the devices via the network;

a determining process of determining the presence or absence of a conflict between the programming information registered in the devices at the time of the detection; and

a notifying process, when occurrence of the conflict in the programming information is detected, for notifying the user of the occurrence of the conflict.

In order to solve the above problems, the invention according to claim 10 relates to a programming management method for managing programming information for programming an operation of a device connected via a network, comprising:

a detecting process of detecting connection to another programming management apparatus via the network;

a determining process of determining the presence or absence of a conflict between the programming information registered in the apparatus itself and the another programming management apparatus at the time of detection; and

a notifying process, when occurrence of the conflict in two pieces of the programming information is detected, for notifying the user of the occurrence of the conflict.

In order to solve the above problems, the invention according to claim 11 relates to a programming management program for making a computer included in a programming management system in which a plurality of programming management apparatuses for managing programming information for programming an operation of a device and the device are connected to each other, function as:

detecting means for detecting that at least two programming management apparatuses are connected to each other via the network;

determining means for determining the presence or absence of a conflict between the programming information registered in the programming management apparatuses at the time of the detection; and

notifying means, when occurrence of the conflict in two pieces of the programming information is detected, for notifying the user of the occurrence of the conflict.

In order to solve the above problems, the invention according to claim 12 relates to a programming management program for making a computer included in a programming management system in which a device capable of registering programming information for programming an operation of the device and a programming management apparatus capable of managing the programming information registered in the device and registering the programming information are connected to each other via a network, function as:

detecting means for detecting that the programming management apparatus and the device are connected to each other via the network;

determining means for determining the presence or absence of a conflict between the programming information registered in the programming management apparatus and the device at the time of the detection; and

notifying means, when occurrence of the conflict in the programming information is detected, for notifying the user of the occurrence of the conflict.

In order to solve the above problems, the invention according to claim 13 relates to a programming management program for making a computer included in a programming management apparatus connected, via a network, to a plurality of devices each capable of registering programming information for programming an operation of the device, and for managing the programming information, function as:

detecting means for detecting connection of each of the devices via the network;

determining means for determining the presence or absence of a conflict between the programming information registered in the devices at the time of the detection; and

notifying means, when occurrence of the conflict in the programming information is detected, for notifying the user of the occurrence of the conflict.

In order to solve the above problems, the invention according to claim 14 relates to a programming management program for making a computer included in a programming management apparatus connected to a device via a network, and for managing programming information for programming an operation of the device, function as:

detecting means for detecting connection to another programming management apparatus via the network;

determining means for determining the presence or absence of a conflict between the programming information registered in the apparatus itself and the another programming management apparatus at the time of detection; and

notifying means, when occurrence of the conflict in two pieces of the programming information is detected, for notifying the user of the occurrence of the conflict.

### BRIEF DESCRIPTION OF THE DRAWINGS

FIG. 1 is a block diagram showing the configuration of a programming management system of a first embodiment.

FIG. 2 is a block diagram showing the configuration of a programming management apparatus of FIG. 1.

FIG. 3 is an explanatory diagram showing programming information of the first embodiment.

FIG. 4 is a flowchart showing operations performed in the case where a programming management apparatus as a master receives a programming registration request.

FIG. 5 is a flowchart showing the flow of processes performed in the case where a conflict is detected in a programming management apparatus 2 in FIG. 4.

FIG. 6 is a flowchart showing the flow of processes performed in the case where a conflict is detected in a programming management apparatus 3 in FIG. 4.

FIG. 7 is a flowchart showing operation performed in the case where a programming management apparatus as a slave receives a programming registration request.

FIG. 8 is a flowchart showing the flow of processes performed in the case where a conflict is detected in the programming management apparatus 3 in FIG. 7.

FIG. 9 is a flowchart showing the flow of processes performed in the case where a conflict is detected in the programming management apparatus 2 in FIG. 7.

FIG. 10 is a flowchart showing operations performed when participation of a programming management apparatus as a slave in a network is detected.

FIG. 11 is a flowchart showing operations performed when participation of a programming management apparatus as a master in a network is detected.

FIG. 12 is a flowchart showing operations of a programming management apparatus as a master when it is detected that a device is connected to a network.

FIG. 13 is a flowchart showing operations of a programming management apparatus as a slave when it is detected that a device is connected to a network.

FIG. 14 is a flowchart showing operations performed when participation of a programming management apparatus as a slave in a network is detected in a second embodiment.

FIG. 15 is a flowchart showing operations performed when participation of a programming management apparatus as a master in a network is detected in the second embodiment.

### DESCRIPTION OF REFERENCE NUMERALS

1 Network
2 Programming management apparatus
3 Programming management apparatus
4 Device
5 Device
7 Requesting/notifying unit
8 Network communication unit
9 Device management unit
10 Programming management unit
11 Programming consistency determining unit
12 Device programming table access unit
13 Programming information management unit
14 Programming database

### BEST MODE FOR CARRYING OUT THE INVENTION

Embodiments of the present invention will be described hereinbelow with reference to the drawings.

The following embodiments relate to the case where the invention is applied to a programming management system for managing schedule of recordings or the like by using devices A to C connected to each other via a network.

In the following description, a network conformed with the IEEE 1394 standard or the like is used as the network. Concrete examples of the devices are AV (Audio Visual) devices such as a digital tuner, a D-VHS (Data VHS), and an AV hard disk. Concrete examples of the programming management apparatus are a digital TV, a digital tuner, a personal computer, and the like.

### (I) Configuration of Programming Management System

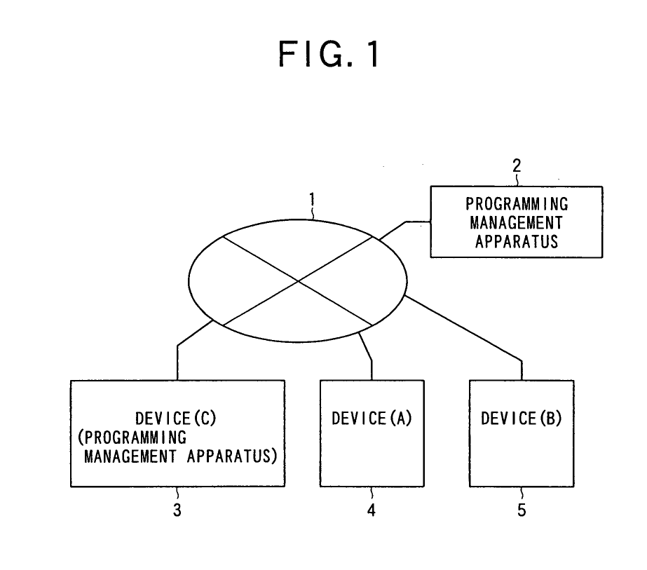

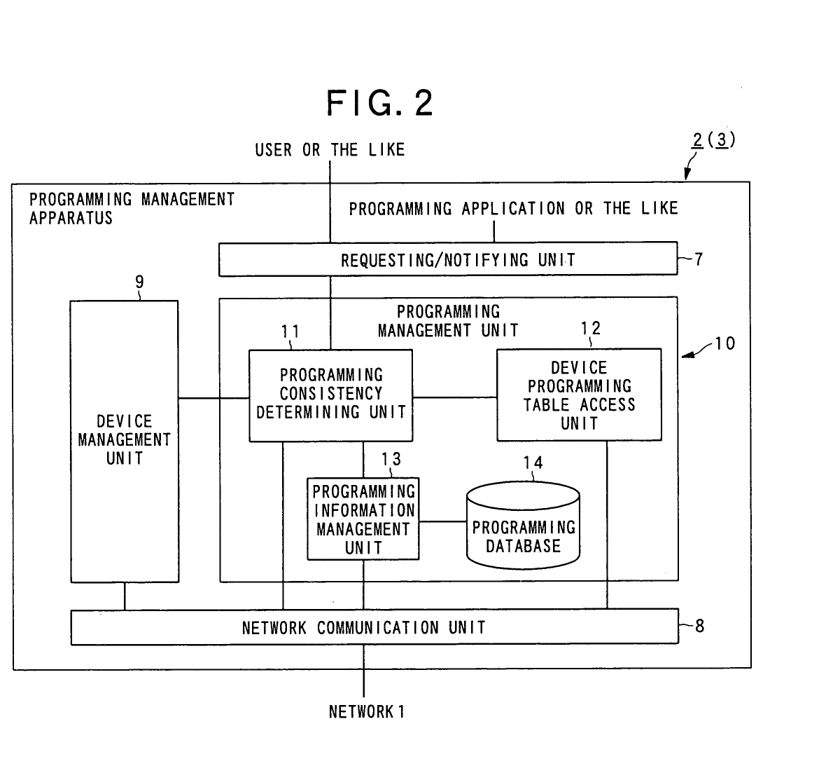

FIG. 1 is a block diagram showing the configuration of a programming management system of a first embodiment, and FIG. 2 is a block diagram showing the configuration of a programming management apparatus in FIG. 1.

As shown in FIG. 1, a network 1 is a network conformed with the IEEE 1394 standard or the like. Via the network 1, a programming management apparatus 2, a device (A) 4, and a device (B) 5 are connected to each other. A device (C) is also connected to each of the programming management apparatus 2 and the devices 4 and 5 via the network 1. Since the device (C) also has the function of a programming management apparatus, in the following description, the device (C) will be called a programming management apparatus 3, the device (A) will be simply called a device 4, and the device (B) will be called a device 5.

In the programming management system constructed as described above, the user performs a remote operation with remote operation means such as a remote controller on the programming management apparatuses 2 and 3, thereby registering programming information in the programming management apparatuses 2 and 3. At designated time, operation commands are transmitted from the programming management apparatuses 2 and 3 to the devices 4 and 5 via the network 1, and desired programming operation is executed in the devices 4 and 5.

### (II) Configuration of Programming Management Apparatus

Next, the configuration of the programming management apparatuses 2 and 3 will be described with reference to FIG. 2.

As shown in FIG. 2, each of the programming management apparatuses 2 and 3 includes, roughly, a requesting/notifying unit 7, a network communication unit 8, a device management unit 9, and a programming management unit 10. The programming management unit 10 includes a programming consistency determining unit 11, a device programming table access unit 12, a programming information management unit 13, and a programming database 14. The requesting/notifying unit 7 corresponds to an example of notifying means of the invention. The network communication unit 8 corresponds to detecting means of the invention. The programming consistency determining unit 11 corresponds to determining means of the invention.

Next, the general operation will be described.

The requesting/notifying unit 7 serves as an interface with the user, a programming application, or the like. When a request to the programming management unit 10 is received from the user, programming application, or the like, the requesting/notifying unit 7 transmits the request information to the programming management unit 10, receives a response from the programming management unit 10, and passes it to the user, programming application, or the like as a requester.

The requesting/notifying unit 7 receives information indicative of the notification generated by the programming management unit 10 and presents it to the user or the like. When the other party is the user, the requesting/notifying unit 7 has the function of a user interface, receives a request made by operating operation members such as a remote controller, keys, a touch panel, and the like and, with respect to a response or notification, displays a graphical image or characters on a display or generates sound. Both of output of characters and sound may be used.

The network communication unit 8 has the function of transmitting/receiving data to/from the other programming management apparatuses 2 and 3 and the devices 4 and 5 via the network 1, and notifying of the device management unit 9 and the programming management unit 10 of a change in the device configuration such as connection and disconnection of a device to/from the network 1.

On receipt of the notification that a device is additionally connected to the network 1 from the network communication unit 8, the device management unit 9 accesses a target device by using service of the network communication unit 8, obtains various information, and specifies the type of the device. In the device management unit 9, whether a target device is a programming management apparatus or not is also determined. The result of determination is output to the programming management unit 10.

As described above, the programming management unit 10 includes the programming consistency determining unit 11, the device programming table access unit 12, the programming information management unit 13, and the programming database 14.

On receipt of a request from the programming consistency determining unit 11, the device programming table access unit 12 in the programming management unit 10 accesses a device having a programming table via the network communication unit 8 and executes a process of reading/writing programming information.

An example of the programming table is a bulletin board subunit (a bulletin board subunit in an AV/C (Audio/Video Control) command) standardized in 1394 TA (Trade Association) The table has the function of a bulletin board (programming table) in which programming information can be freely written. By referring to the programming table, the schedule of recordings using the device can be grasped.

However, the programming table does not prevent writing of information of conflicting recordings. Whether recordings can be scheduled or not, in other words, whether recordings conflict each other or not is determined by the device to which a programming entry is written. Consequently, it is impossible to recognize that recordings can be scheduled or not, that is, no conflict occurs in recordings by using only the programming table.

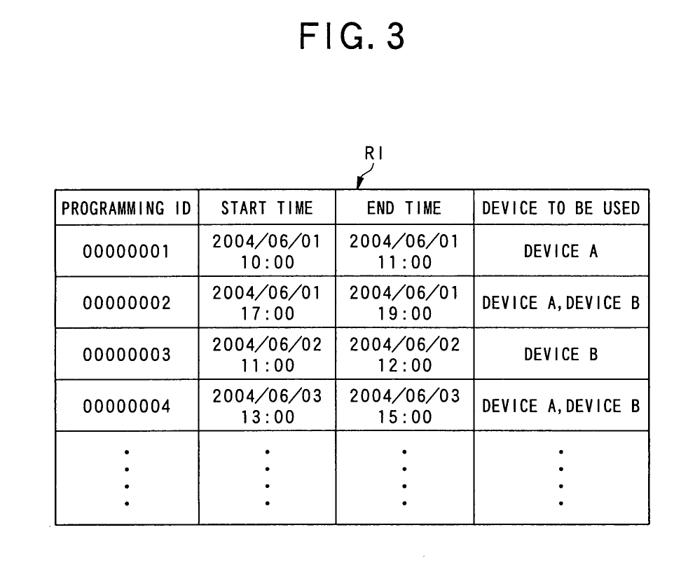

The programming information management unit 13 forms a database of information related to registered recordings and manages the programming database 14 for recording and holding the information. FIG. 3 shows an example of recording information RI of the registered recordings. The recording information RI is registered, erased, or updated in response to a request from the programming consistency determining unit 11. When a programming information obtaining request from another programming management apparatus is received via the network communication unit 8, the programming information management unit 13 extracts necessary programming information and transmits the extracted information to the requester.

As the recording information RI, as shown in FIG. 3, information indicative of recording ID (identification), start time of the recording, end time of the recording, and a device to be used for the recording is recorded in the programming database 14.

Concretely, for example, in the case where the recording ID is “00000001”, the start time of the recording or the like is 10:00 on Jun. 1, 2004, the end time is 11:00 on Jun. 1, 2004, and the device to be used is the device 4. In the case where the recording ID is “00000002”, the start time of the recording or the like is 17:00 on Jun. 1, 2004, the end time is 19:00 on Jun. 1, 2004, and the device to be used is the devices 4 and 5. In the case where the recording ID is “00000003”, the start time of the recording or the like is 11:00 on Jun. 2, 2004, the end time is 12:00 on Jun. 2, 2004, and the device to be used is the device 5. In the case where the recording ID is “00000004”, the start time of the recording or the like is 13:00 on Jun. 3, 2004, the end time is 15:00 on Jun. 3, 2004, and the device to be used is the devices 4 and 5.

The programming consistency determining unit 11 in FIG. 2 receives a request for registering, canceling, or changing a recording from the user, the programming application, or the like via the requesting/notifying unit 7. The programming consistency determining unit 11 executes a process of checking a recording conflict state and determining whether the request can be accepted or not.

A conflict with the recording is determined by the programming consistency determining unit 11 inquiring the programming information management unit 13 with reference to information already registered. When a plurality of programming management apparatuses exist on the network 1, the programming consistency determining unit 11 asks another programming management apparatus to check a recording conflict, thereby recognizing a recording conflict state on the whole network 1. When there is no problem with scheduling of the recording, the recording information is registered in the programming database 14 by the programming management unit 13. When a device used for the recording has a recording table, writing of the recording information RI to the device is requested to the device programming table access unit 12.

The programming consistency determining unit 11 receives a notification that a device or a programming management apparatus has participated in (hereinbelow, also called, “is connected to”) the network 1 from the device management unit 9. When the notification that the programming management apparatus has participated in the network 1 has received, the programming information management unit 13 checks consistency between recording information managed by the programming information management unit 13 and the recording information RI managed by the target programming management apparatus, thereby recognizing a recording conflict state in the network 1.

Further, in the case where a device having a programming table participates in the network 1, the programming consistency determining unit 11 requests the device programming table access unit 12 to obtain the recording ID information RI and checks the state of a conflict with the programming information managed by the programming information management unit 13. When the conflict state is detected in any of the cases, the fact is notified to the user or the like via the requesting/notifying unit 7. The recording information of a conflicting recording is also provided to the user or the like.

In the case where a plurality of programming management apparatuses exist on the network 1 as shown in FIG. 1, an exclusive control of the recording conflict check process is executed by one recording management apparatus as a representative so that conflict does not occur in consistency of recordings on the whole network 1 at the time of registering a recording, or the like. Consequently, “master attribute information” as attribute information indicating whether a programming management apparatus is a representative or not is defined. The master attribute of the programming management apparatus 2 as a representative is set as “master”, and the master attribute of the programming management apparatus 3 other than the representative is set as “slave”. The setting of the master attribute is determined on the basis of the value of a device identifier such as the GUID (Global Unique Identifier) of the programming management apparatus. Concretely, a method of setting a programming management apparatus having the largest value of the device identifier as a “master” can be used.

### (III) Operation of Programming Management System

### Operation Performed on Reception of Recording Registration Request

An example of a system configuration on the network 1, having two devices and two programming management apparatuses as shown in FIG. 1 will be described.

(1-1) Operation Performed in the Case where the Programming Management Apparatus 2 as a Master Receives Recording Registration Request

Since the programming management apparatus 2 as a master and the programming management apparatus 3 as a slave have the same configuration, in the following flowchart, for convenience, “a” is added to the reference numerals like a requesting/notifying unit 7a, a programming management unit 10a, and a programming database 14a in the programming management apparatus 2 as a master. “b” is added to the reference numerals like a requesting/notifying unit 7b, a programming management unit 10b, and a programming database 14b in the programming management apparatus 3 as a slave.

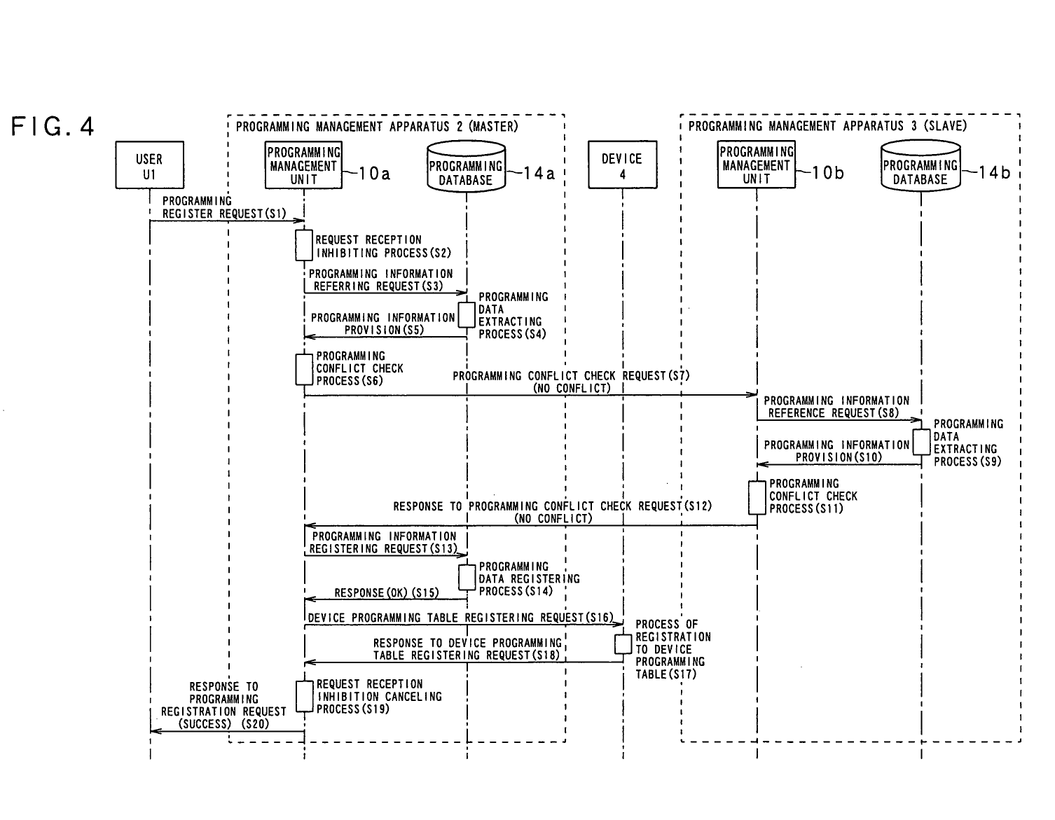

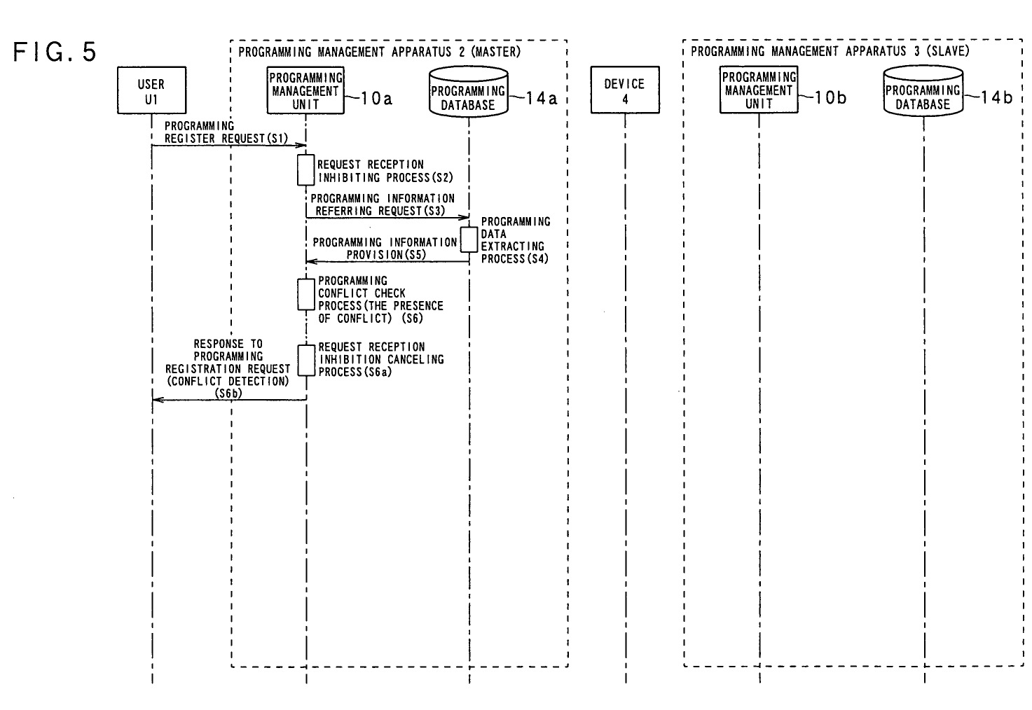

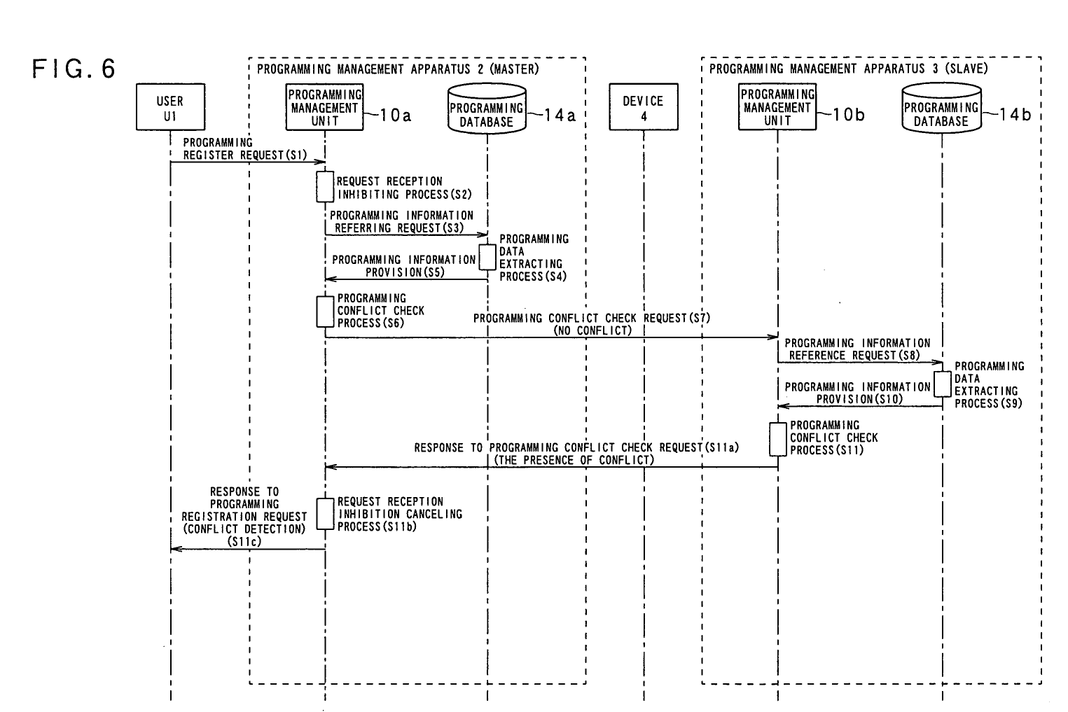

When the requesting/notifying unit 7a in the programming management apparatus 2 as a master receives information indicative of a recording registration request from the user or the like, the information is output to the programming management unit 10a in the programming management apparatus 2. FIGS. 4 to 6 show the flow of the processes in the whole system. FIG. 4 is a flowchart showing the flow of processes performed in the case where a recording registration request is made and a recording registration succeeds. FIG. 5 is a flowchart showing the flow of processes performed in the case where a conflict is detected by the programming management apparatus 2. FIG. 6 is a flowchart showing the flow of processes performed in the case where a conflict is detected by the programming management apparatus 3.

First, operations performed in the case where a-recording registration request is made and a recording registration succeeds will be described with reference to FIG. 4.

As shown in FIG. 4, first, when a user U1 operates an operating member such as a remote controller, keys, a touch panel, or the like and the programming management unit 10a in the programming management apparatus 2 receives a recording registration request via the requesting/notifying unit 7a (step S1), the programming management unit 10a is set in a state where reception of a recording registering/updating request is inhibited (step S2).

Next, when the programming management unit 10a sends a programming information reference request to the programming database 14a in step S3, the programming database 14a executes a recording data extracting process (step S4) and, after that, provides the recording information to the programming management unit 10a (step S5). That is, the programming management unit 10a retrieves all of programming data registered in the programming database 14a and checks the presence/absence of a conflict by comparing the retrieved data with the requested recording information (hereinbelow, called a conflict check) (step S6).

When it is determined in step S6 that there is no conflict, information indicative of a recording conflict check request for the requested recording data is transmitted to the programming management apparatus 3 (step S7).

When the programming management unit 10b in the programming management apparatus 3 which receives the recording conflict check request information sends a recording information reference request to the programming database 14b in step S8, the programming database 14b executes the recording data extracting process (step S9) and provides the recording information to the programming management unit 10b (step S10). Specifically, the programming management unit 10b retrieves all of data registered in the programming database 14b held by the programming management unit 10b itself, and compares it with the recording information received from the programming management apparatus 2, thereby making a conflict check (step S11). In the case where the received recording data is not data indicative of a conflict, a response indicative of the fact is transmitted to the programming management unit 10a in the programming management apparatus 2 (step S12).

Next, the programming management apparatus 2 requests the programming database 14a to register the recording information (step S13). The programming database 14a executes the process of registering the request recording information (step S14) and sends a response (step S15).

Further, the programming management apparatus 2 requests the device 4 to register a device programming table (step S16). In the case where the device 4 used for the recording operation has a writable device programming table, the programming management apparatus 2 performs a process of registering the recording information into the device programming table and sends a response to the registering request from the programming management apparatus 2 (steps S17 and S18).

Subsequently, the programming management apparatus 2 cancels the recording registering/updating request reception inhibiting state which is set in step S2 and outputs, as a response to the request, information indicative of success in the recording registration to the user U1 via the requesting/notifying unit 7a (steps S19 and S20).

The operations performed in the case where the programming management apparatus 2 detects a conflict will be described with reference to FIG. 5. The processes in steps S1 to S6 are similar to those of the flowchart shown in FIG. 4 and their description will not be repeated.

As shown in FIG. 5, in the case where the recording information conflicts with an already registered recording in step S6, the programming management unit 10a cancels the recording registering/updating request reception inhibiting state which is set in step S2 (step S6a). After that, the programming management unit 10a outputs information indicative of the conflict to the user U1 via the requesting/notifying unit 7a as a response to the recording registration request (step S6b).

Further, the operations performed in the case where a conflict is detected by the programming management apparatus 3 will be described with reference to FIG. 6. The processes in steps S1 to S11 are similar to those of the flowchart of FIG. 4 and their description will not be repeated.

As shown in FIG. 6, in step S11, the programming management unit 10b retrieves all of data registered in the programming database 14b held by the programming management unit 10b itself and makes a conflict check by comparing the retrieved data with the recording information received from the programming management apparatus 2 (step S11). In the case where a conflict is detected, a response indicative of the presence of the conflict is transmitted to the programming management unit 10a in the programming management apparatus 2 (step S11a).

Subsequently, the programming management unit 10a cancels the recording registering/updating request reception inhibiting state which is set in step S2 (step S11b) and outputs, as a response to a recoding registration request indicative of the conflict to the user U1 via the requesting/notifying unit 7a (step S11c).

(1-2) Operation Performed in the Case where the Programming Management Apparatus 3 as a Slave Receives Recording Registration Request

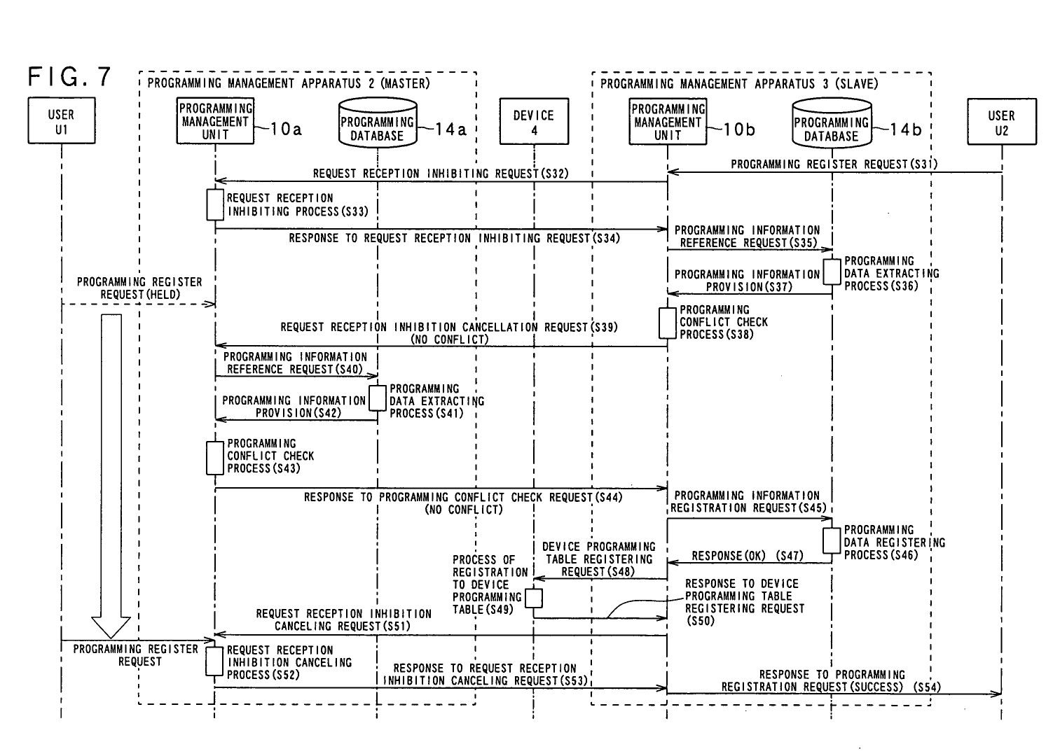

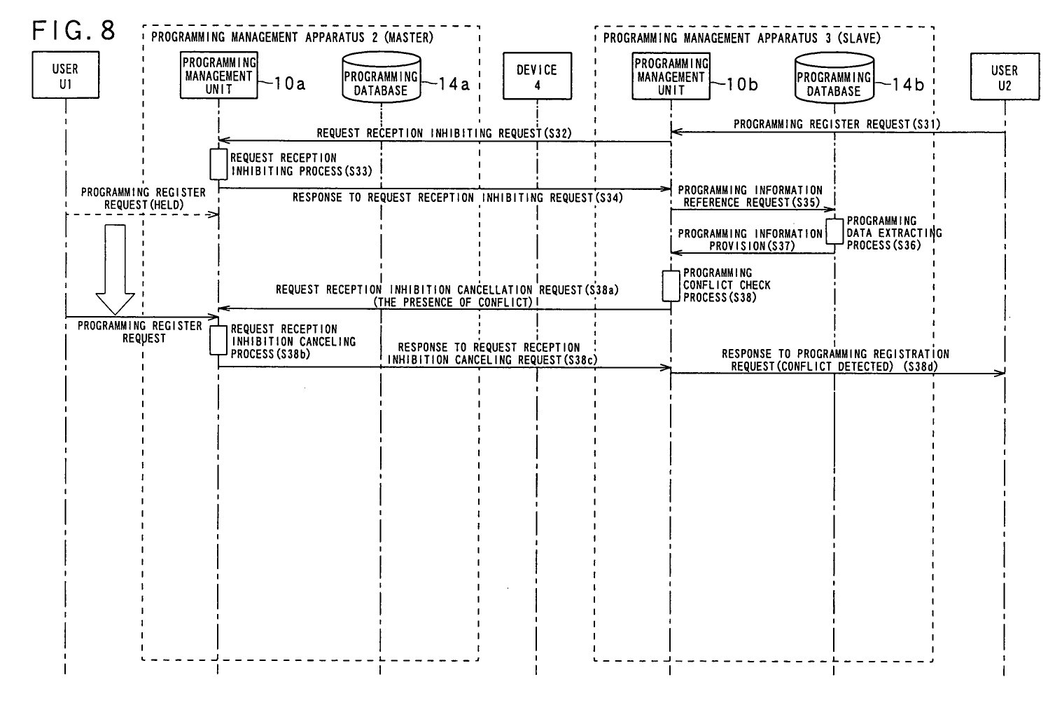

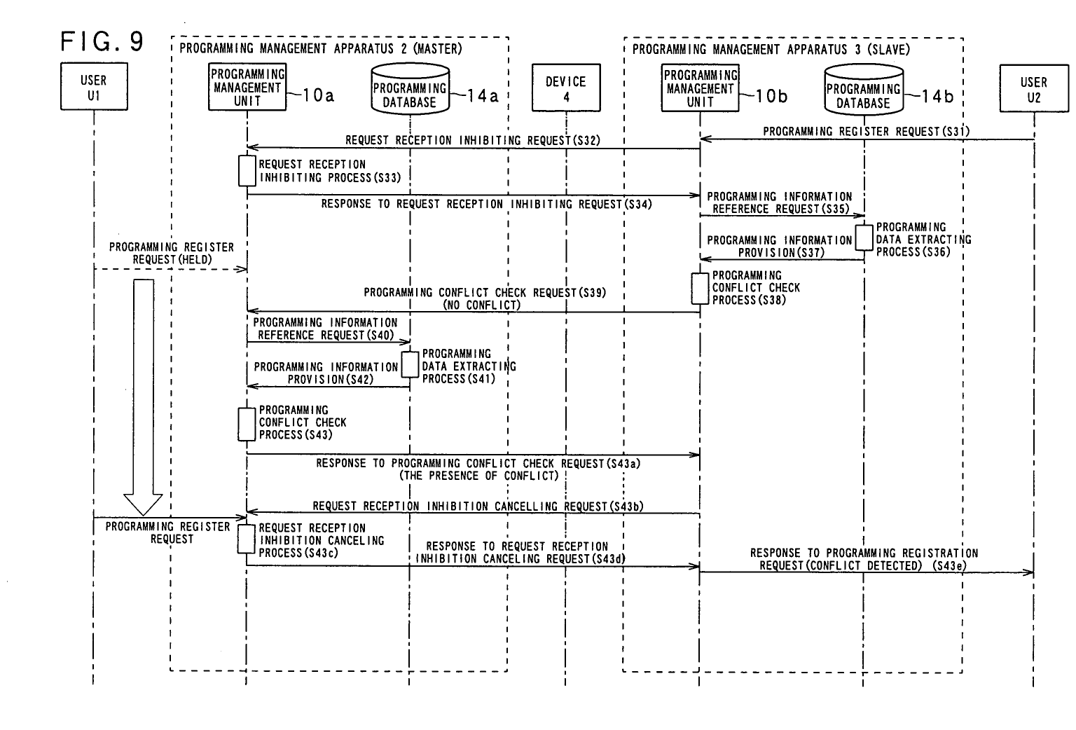

When the requesting/notifying unit 7b in the programming management apparatus 3 as a slave receives information indicative of a recording registration request from the user or the like, the information is output to the programming management unit 10b in the programming management apparatus 3. FIGS. 7 to 9 show the flow of the processes in the whole system. FIG. 7 is a flowchart showing the flow of processes performed in the case where a recording registration request is made and a recording registration succeeds. FIG. 8 is a flowchart showing the flow of processes performed in the case where a conflict is detected by the programming management apparatus 3. FIG. 9 is a flowchart showing the flow of processes performed in the case where a conflict is detected by the programming management apparatus 2.

First, operations performed in the case where a recording registration request is made and a recording registration succeeds will be described with reference to FIG. 7.

As shown in FIG. 7, first, when a user U2 operates an operating member such as a remote controller, keys, a touch panel, or the like and the programming management unit 10b in the programming management apparatus 3 as a slave receives a recording registration request via the requesting/notifying unit 7b (step S31), the programming management unit 10b transmits information indicative of a request for inhibiting reception of a recording registering/updating request to the programming management unit 10a in the programming management apparatus 2 (step S32).

The programming management unit 10a in the programming management apparatus 2 which receives the reception inhibition request information sets a recording registering/updating request reception inhibiting state in step S33 and, after that, sends a response to the reception inhibition requesting information to the programming management unit 10b in the programming management apparatus 3 (step S34).

When the programming management unit 10b in the programming management apparatus 3 which receives the information indicative of the response sends a programming information reference request to the programming database 14b in step S35, the programming database 14b executes a recording data extracting process (step S36) and, after that, provides the recording information to the programming management unit 10b (step S37). That is, the programming management unit 10b retrieves all of programming data registered in the programming database 14b and makes a conflict check by comparing the retrieved data with the requested recording information (step S38).

When it is determined in step S38 that there is no conflict, information indicative of a recording conflict check request for the requested recording data is transmitted to the programming management apparatus 2 (step S39). When the programming management apparatus 2 which receives the recording conflict check request information sends a recording information reference request to the programming database 14a in step S40, the programming database 14a executes the recording data extracting process (step S41) and provides the recording information to the programming management unit 10a (step S42). Specifically, the programming management unit 10a retrieves all of data registered in the programming database 14a held by the programming management unit 10a itself, compares it with the recording information received from the programming management apparatus 3, thereby making a conflict check (step S43), sends the result to the programming management unit 10b in the programming management apparatus 3. Therefore, in the case where a response to the recording conflict check request does not indicate a conflict, the fact is transmitted to the programming management unit 10b in the programming management apparatus 2 (step S44).

Next, the programming management unit 10b requests the programming database 14b to register the recording information (step S45). The programming database 14b executes the process of registering the requested recording information (step S46) and sends a response indicative of the registration to the programming management unit 10b (step S47).

Further, the programming management unit 10b in the programming management apparatus 3 requests the device 4 to register a device programming table (step S48). In the case where the device 4 used for the recording operation has a writable device programming table, the programming management unit 10b performs a process of registering the recording information into the device programming table and sends a response to the registering request (steps S49 and S50).

Subsequently, the programming management apparatus 3 transmits information indicative of a recording registering/updating request reception inhibition canceling request to the programming management apparatus 2 as a master (step S51). The programming management apparatus 2 that receives the reception inhibition canceling request cancels the recording registering/updating request reception inhibiting state and, after that, sends a response back (steps S52 and S53). The programming management unit 10b in the programming management apparatus 3 which receives the response outputs, as a response to the request, information indicative of the fact that the recording registration has succeeded to the user U2 via the requesting/notifying unit 7b (step S54).

In the case where the recording registration request from the user U1 is received by the programming management apparatus 2 during execution of the process based on the recording registration request from the user U2 in FIG. 7, the recording registration request is held until the process for the request from the user U2 is completed, that is, until information indicative of the recording registering/updating request reception inhibition canceling request is transmitted (step S51) in FIG. 7. After completion of the process, the recording registering process is newly started by the programming management unit 10a. However, when a conflicting recording has been already registered, the request fails.

Next, the operations performed in the case where a conflict is detected by the programming management apparatus 3 will be described with reference to FIG. 8. The processes in steps S31 to S38 are similar to those of the flowchart shown in FIG. 7 and their description will not be repeated.

As shown in FIG. 8, in the case where the recording information conflicts with an already registered recording in step S38, the programming management unit 10b transmits information indicative of the request for cancelling the recording registering/updating request reception inhibiting state which is set in step S33 to the programming management apparatus 2 as a master (step S38a). After performing the process of cancelling the recording registering/updating request reception inhibiting state in step S38b, the programming management unit 2 which receives the information sends back a response to the request for cancelling the recording registering/updating request reception inhibiting state (step S38c). The programming management unit 10b in the programming management apparatus 3 which receives the response outputs information indicative of the conflict to the user U2 via the requesting/notifying unit 7b as a response to the recording registration request (step S38d).

In FIG. 8, in the case where the recording registration request from the user U1 is received by the programming management apparatus 2 during execution of the process based on the recording registration request from the user U2, the recording registration request is held until the process for the request from the user U2 is completed, that is, until information indicative of the recording registering/updating request reception inhibition canceling request is transmitted (step S38b) in FIG. 8. After completion of the process, the recording registering process is newly started by the programming management unit 10a.

Further, the operations performed in the case where a conflict is detected by the programming management apparatus 2 will be described with reference to FIG. 9. The processes in steps S31 to S43 are similar to those of the flowchart of FIG. 7 and their description will not be repeated.

As shown in FIG. 9, in step S43, a conflict check is made. When a response to the recording conflict check request indicates the presence of a conflict, the fact is output to the programming management unit 10b in the programming management apparatus 3 (step S43a).

Subsequently, the programming management unit 10b transmits information indicative of a request for cancelling the recording registering/updating request reception inhibiting state which is set in step S33 to the programming management apparatus 2 as a master (step S43b). The programming management apparatus 2 which receives the information performs a process of cancelling the recording registering/updating request reception inhibiting state in step S43c and, after that, sends a response to the request for cancelling the recoding registering/updating request reception inhibiting state (step S43d). The programming management unit 10b in the programming management apparatus 3 which receives the response outputs, as a response to the recording registering request, the fact indicative of the presence of a conflict to the user U2 via the requesting/notifying unit 7b (step S43e).

In the case where the recording registration request from the user U1 is received by the programming management apparatus 2 during execution of the process based on the recording registration request from the user U2 in FIG. 9, in a manner similar to FIGS. 7 and 8, the recording registration request is held until the process for the request from the user U2 is completed, that is, until information indicative of the request for cancelling the recording registering/updating request reception inhibition is transmitted (step S43c) in FIG. 9. After completion of the process, the recording registering process is newly started by the programming management unit 10a.

(2) Operation Performed in the Case where Participation of Programming Management Apparatus in Network is Detected
(2-1) Operation Performed in the Case where Participation of the Programming Management Apparatus 3 as a Slave in Network is Detected

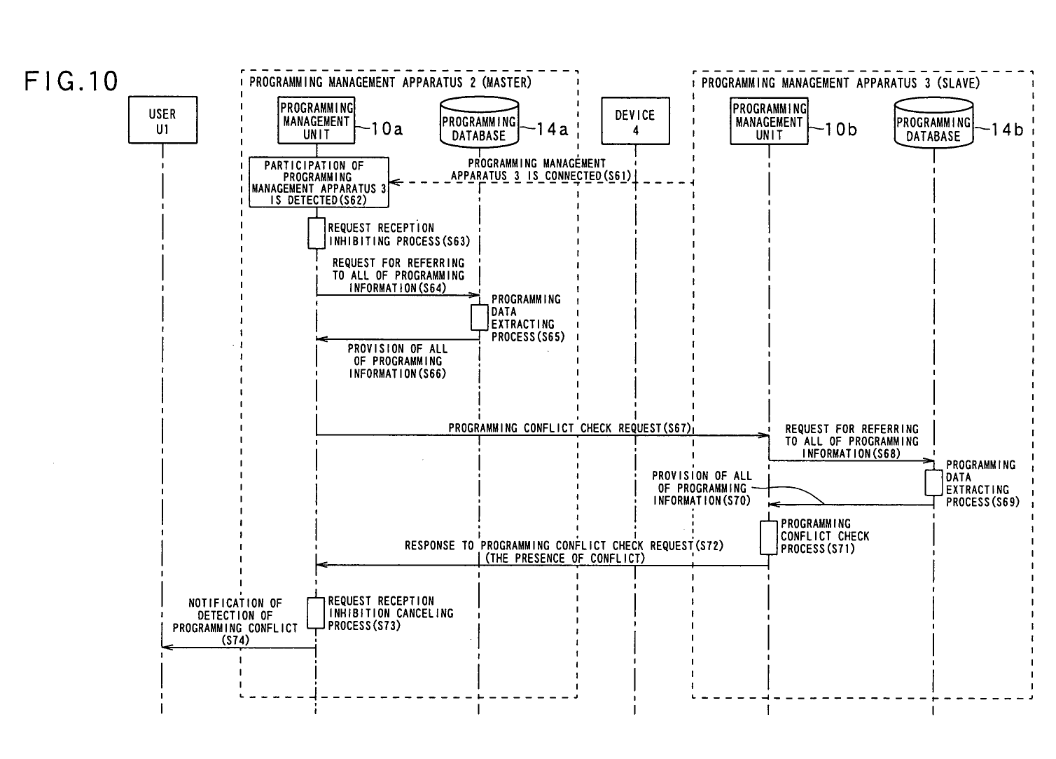

FIG. 10 shows the flow of processes in the whole system performed when it is detected in the programming management apparatus 2 as a master that the programming management apparatus 3 as a slave is connected via the network 1.

As shown in FIG. 10, first, in the case where the programming management unit 10a in the programming management apparatus 2 detects participation of the programming management apparatus 3, the programming management unit 10a is set in the recording registering/updating request reception inhibiting state (steps S61 to S63).

When the programming management unit 10a sends a programming information reference request to the programming database 14a in step S64, the programming database 14a executes a recording data extracting process (step S65) and, after that, provides all of the recording information to the programming management unit 10a (step S66). That is, the programming management unit 10a retrieves all of programming data registered in the programming database 14a and transmits information of the request for a recording conflict check on the data to the programming management apparatus 3 (step S67).

When the programming management apparatus 3 that receives the recording conflict check request information sends a programming information reference request to the programming database 14b in step S68, the programming database 14b executes a recording data extracting process (step S69) and, after that, provides all of the recording information to the programming management unit 10b (step S70). That is, the programming management unit 10b retrieves all of programming data registered in the programming database 14b held by the programming management unit 10b itself, makes a conflict check by comparing the extracted data with the recording data received from the programming management apparatus 2 (step S71), and transmits the result to the programming management apparatus 2 (step S72).

Subsequently, the programming management apparatus 2 which receives a response to the programming check request cancels the recording registering/updating request reception inhibiting state (step S73). After that, when it is detected that the received result shows a conflict state, the programming management apparatus 2 notifies the user U1 of occurrence of the conflict state via the requesting/notifying unit 7a in the programming management apparatus 2 (step S74).

(2-2) Operation Performed in the Case where Participation of the Programming Management Apparatus 2 as a Master in Network is Detected

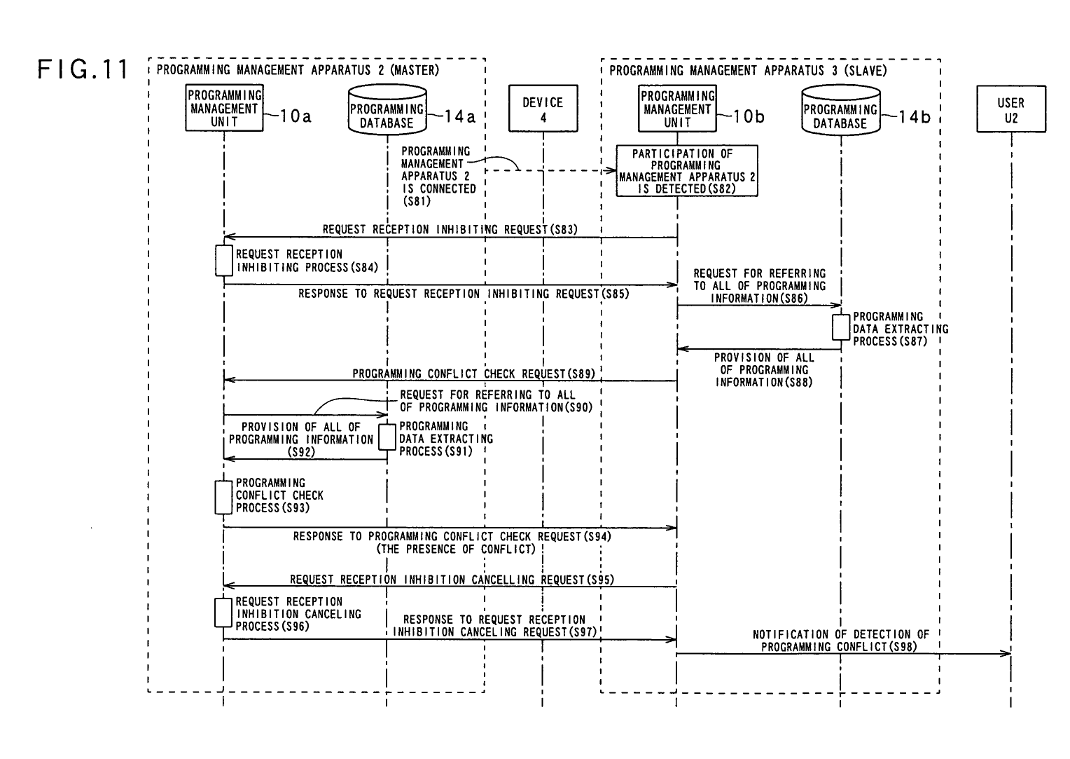

FIG. 11 shows the flow of processes in the whole system performed when it is detected in the programming management apparatus 3 as a slave that the programming management apparatus 2 as a master is connected via the network 1.

As shown in FIG. 11, first, in the case where the programming management unit 10b in the programming management apparatus 3 detects participation of the programming management apparatus 2, the programming management unit 10b transmits information indicative of a request for inhibiting reception of a recording registering/updating request to the programming management apparatus 2 (steps S81 to S83).

When the programming management unit 10a in the programming management apparatus 2 which receives the reception inhibition request information sets a recording registering/updating request reception inhibiting state and, after that, sends back a response to the request reception inhibition request (steps S84 and S85).

When the programming management apparatus 3 that receives a response to the request reception inhibiting request sends a programming information reference request to the programming database 14b in step S86, the programming database 14b executes a recording data extracting process (step S87) and, after that, provides all of the recording information to the programming management unit 10b (step S88). That is, the programming management unit 10b retrieves all of programming data registered in the programming database 14b, and transmits information indicative of the recording conflict check request for the data to the programming management apparatus 2 (step S89).

When the programming management apparatus 2 which receives a response to the programming conflict check request sends a programming information reference request to the programming database 14a in step S90, the programming database 14a executes a recording data extracting process (step S91) and, after that, provides the recording information to the programming management unit 10a (step S92). That is, the programming management unit 10a retrieves all of programming data registered in the programming database 14a, makes a conflict check by comparing the retrieved data with recording data received from the programming management apparatus 3 (step S93), and transmits the result to the programming management apparatus 3 (step S94).

Next, the programming management apparatus 3 which receives a response to the recording conflict check request transmits information indicative of a request for cancelling the recording registering/updating request reception inhibition to the programming management apparatus 2 as a master in step S95. The programming management apparatus 2 which receives information indicative of the reception inhibiting canceling request cancels the recording registering/updating request reception inhibiting state (step S96) and, after that, sends back a response (step S97). In the case where the programming management apparatus 3 which receives the response detects that the result of the conflict check request received before shows a conflict state, the programming management apparatus 3 notifies the user U2 of occurrence of the conflict state via the requesting/notifying unit 7b in the programming management apparatus 3 (step S98).

The above-described two operations performed when the programming management apparatuses 2 and 3 are connected to the network 1 are started almost simultaneously. In the case where the recording registering/updating request reception inhibiting request from the programming management apparatus 3 is received when the programming management apparatus 2 as a master is set in the recording registering/updating request reception inhibiting state, the request itself is held. Therefore, after completion of all of the conflict check process started by the programming management apparatus 2, the conflict check process started by the programming management apparatus 3 is sequentially executed.

(3) Operation Performed when Participation of Device in Network is Detected
(3-1) Operation of Programming Management Apparatus as Master Performed when Connection of Device to Network is Detected

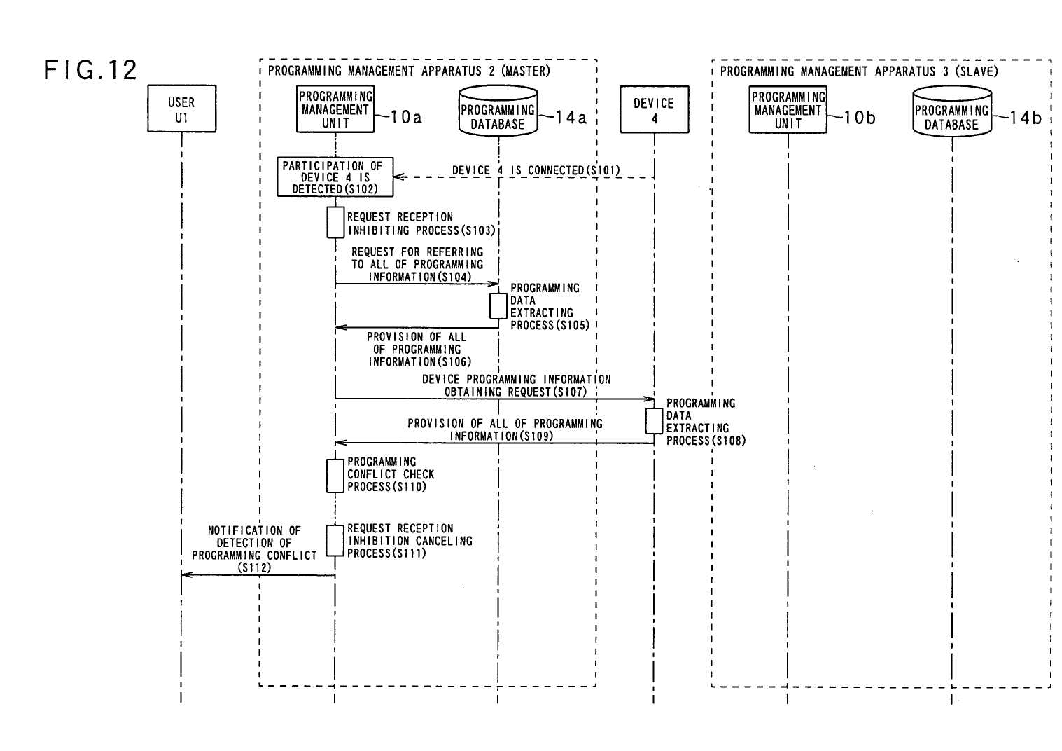

FIG. 12 shows the flow of processes in the programming management apparatus 2 when connection of the device 4 to the network is detected in the programming management apparatus 2 as a master.

As shown in FIG. 12, first, in the case where the programming management unit 10a in the programming management apparatus 2 detects participation of the device 4, the programming management unit 10a is set in the recording registering/updating request reception inhibiting state (steps S101 to S103).

When the programming management unit 10a sends a programming information reference request to the programming database 14a in step S104, the programming database 14a executes a recording data extracting process (step S105) and, after that, provides all of the recording information to the programming management unit 10a (step S106). That is, the programming management unit 10a retrieves all of programming data registered in the programming database 14a.

Subsequently, the programming management unit 10a accesses the recording table in the device 4 via a device programming table access unit 12a and extracts all of recording information registered in the device 4 (steps S107 to S109).

Further, the programming management unit 10a makes a conflict check by comparing the recording data extracted from the programming database 14a with the recording data received from the device 4 (step S110). After cancellation of the recording registering/updating request reception inhibiting state in step S111, when it is detected that a result of the conflict check shows occurrence of a conflict, the user U1 is notified of the occurrence of a conflict via the requesting/notifying unit 7a (step S112).

(3-2) Operation of Programming Management Apparatus as Slave when Connection of Device to Network is Detected

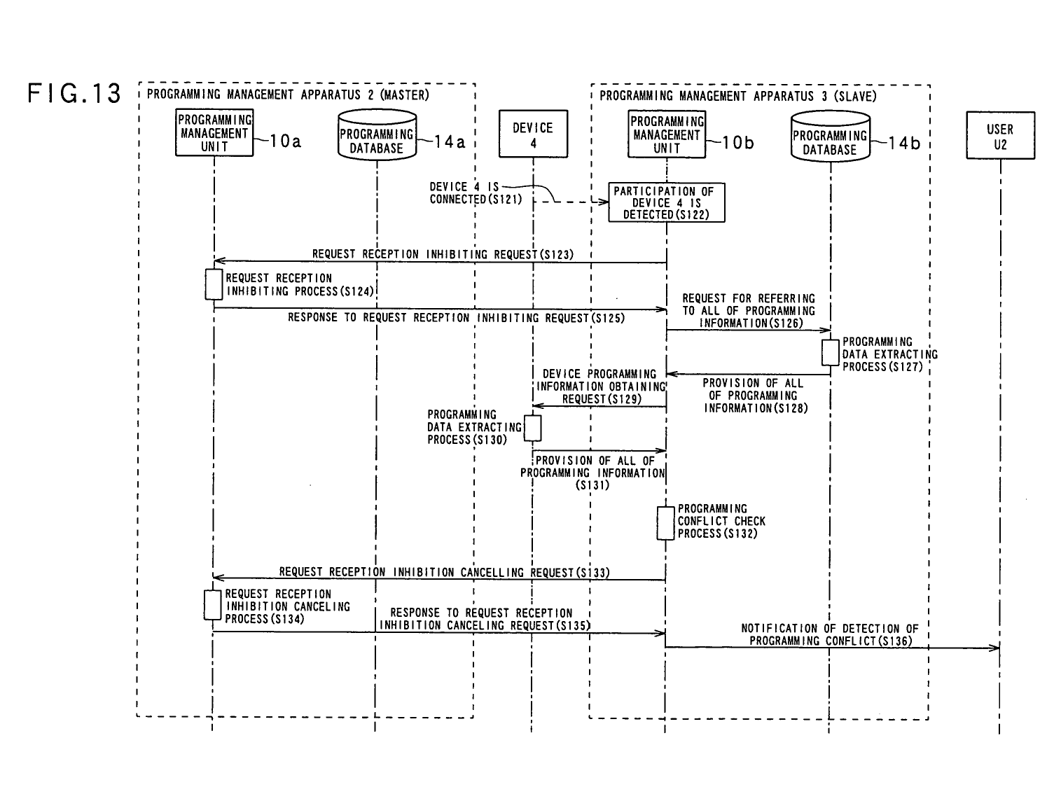

FIG. 13 shows the flow of processes in the whole system in the programming management apparatus 3 performed when it is detected in the programming management apparatus 3 as a slave that the device 4 is connected via the network.

As shown in FIG. 13, first, when the programming management unit 10b in the programming management apparatus 3 detects participation of the device 4, the programming management unit 10b transmits information indicative of a request for inhibiting reception of a recording registering/updating request to the programming management apparatus 2 as a master (steps S121 to S123).

Next, the programming management apparatus 2 which receives the information indicative of the reception inhibiting request sets a recording registering/updating request reception inhibiting state and, after that, sends back a response to the reception inhibiting request (steps S124 and S125).

The programming management apparatus 3 which receives the response to the reception inhibition request sends a request for referring to all of recording information to the programming database 14b in step S126. The programming database 14b executes a recording data extracting process (step S127) and, after that, provides all of the recording information to the programming management unit 10b (step S128). That is, the programming management unit 10b retrieves all of programming data registered in the programming database 14b.

Subsequently, the programming management unit 10b accesses the recording table in the device 4 via a device programming table access unit 12b and extracts all of recording information registered in the device 4 (steps S129 to S131).

Further, the programming management unit 10b makes a conflict check by comparing the recording data extracted from the programming database 14b with the recording data received from the device 4 (step S132). The programming management apparatus 3 transmits information indicative of the request for cancelling inhibition of reception of the recording registering/updating request to the programming management apparatus 2 as a master in step S133.

The programming management apparatus 2 which receives the information of the reception inhibition canceling request cancels the recording registering/updating request reception inhibiting state and, after that, sends back the response to the programming management apparatus 3 (steps S134 and S135).

In the case where the programming management apparatus 3 which receives the response detects that the result of the conflict check shows a conflict state, the user U2 is notified of occurrence of the conflict state via the requesting/notifying unit 7b in the programming management apparatus 3.

When the device 4 is connected to the network 1 in a state where the programming management apparatuses 2 and 3 are connected to each other via the network 1, the above-described two operations are started almost simultaneously. In the case where the recording registering/updating request reception inhibiting request from the programming management apparatus 3 is received when the programming management apparatus 2 as a master is set in the recording registering/updating request reception inhibiting state, the request itself is held. Therefore, after completion of all of the conflict check process started by the programming management apparatus 2, the conflict check process started by the programming management apparatus 3 is sequentially executed.

Concrete examples of means for notifying the user or the like of a conflict will now be described. The notifying means is either display means or communication means.

Concretely, first display means as the notifying means is a display device provided for the programming management apparatus 2 or 3. By displaying characters or a graphical message on the display device, a message can be notified.

Second display means is a sound generator provided for the programming management apparatus 2 or 3. By generating sound from the sound generator, a message can be notified.

Further, when the programming management apparatus 2 or 3 also has a telephone function, first communication means as notifying means can notify of a message by using telephone or cellular phone by pre-registering the telephone number of the apparatus of which a conflict is notified.

In the case where the programming management apparatus 2 or 3 has a facsimile function, second communication means can notify of a message by using a facsimile by pre-registering facsimile number of the apparatus of which a conflict is notified.

In the case where the programming management apparatus 2 or 3 has an e-mail transmission function, third communication means can notify of a message by using an e-mail by pre-registering the e-mail address of the apparatus of which a conflict is notified.

### (IV) Effect of Programming Management System

Each of the programming management apparatuses 2 and 3 is not always limited to a desktop device but may have a form of a portable information terminal or the like. Consequently, it is necessary to consider participation/withdrawal of the programming management apparatuses 2 and 3 to/from the network 1 like in the embodiment.

In the case where the programming management apparatuses 2 and 3 are connected to the network 1 by radio, it has to be also considered that the connection is temporarily interrupted depending on the propagation state of electric waves and the like. That is, there is the possibility that a conflicting recording is registered in the period in which the programming management apparatuses 2 and 3 do not exist in (are disconnected from) the network 1.

Further, a device used for a recording programming operation such as a digital tuner or a D-VHS device to which the invention is applied in the embodiment is used by being connected to a network. Consequently, it is necessary to consider the possibility that, in a state where the connection to the network of the programming management apparatus is interrupted, recording information is registered in a device programming table by another programming management apparatus. In the case where a predetermined operation is performed in a state where conflicting recordings are registered, the conflicting recordings may cause a problem. At worst, both of the recordings fail. As one of means for avoiding such a state, means for notifying the user of occurrence of a recording conflict state is necessary.

As described above, the programming management system of the embodiment detects that the programming management apparatuses 2 and 3 are connected to each other via the network 1, determines the presence or absence of a conflict between recording information recorded in the programming management apparatuses 2 and 3 and, when a conflict exists in the recording information, notifies the user of the conflict.

In the embodiment, when the programming management apparatus 2 detects another programming management apparatus 3 connected via the network 1 or the device 4 having the recording table, the programming management apparatus 2 makes a conflict check with already registered recording information and, when a conflict is detected, notifies the user or the like of the conflict.

Therefore, according to the embodiment, by making the user aware of a recording conflict caused without knowing it, for example, a countermeasure such as cancellation of one of conflicting recordings can be taken. As a result, a failure in a programmed recording operation due to the conflict of recordings in a device can be prevented, and an effect such that usability for the user can be improved.

According to the embodiment, when the programming management apparatus 2 detects connection to a network of the device 3 having the bulletin board subunit, the programming management apparatus 2 extracts the recording information from the device, detects a conflict state by making a conflict check, and notifies the user or the like of the detection result. Thus, the user can recognize a conflict state and a recording conflict can be avoided.

### (V) Operation of Programming Management System in Second Embodiment

(1) Operation Performed when Participation of Programming Management Apparatus in Network is Detected

In the foregoing first embodiment, as shown in FIGS. 10 and 11, by transmitting a conflict check request to a detected programming management apparatus, a recording conflict check process is performed by a programming management apparatus which has detected the other apparatus. In a second embodiment, a programming management apparatus obtains recording information from a detected programming management apparatus and performs a conflict check process by itself.

Since the configuration of a programming management system and a programming management apparatus in the second embodiment is the same as that of the first embodiment, its configuration will not be repeated.

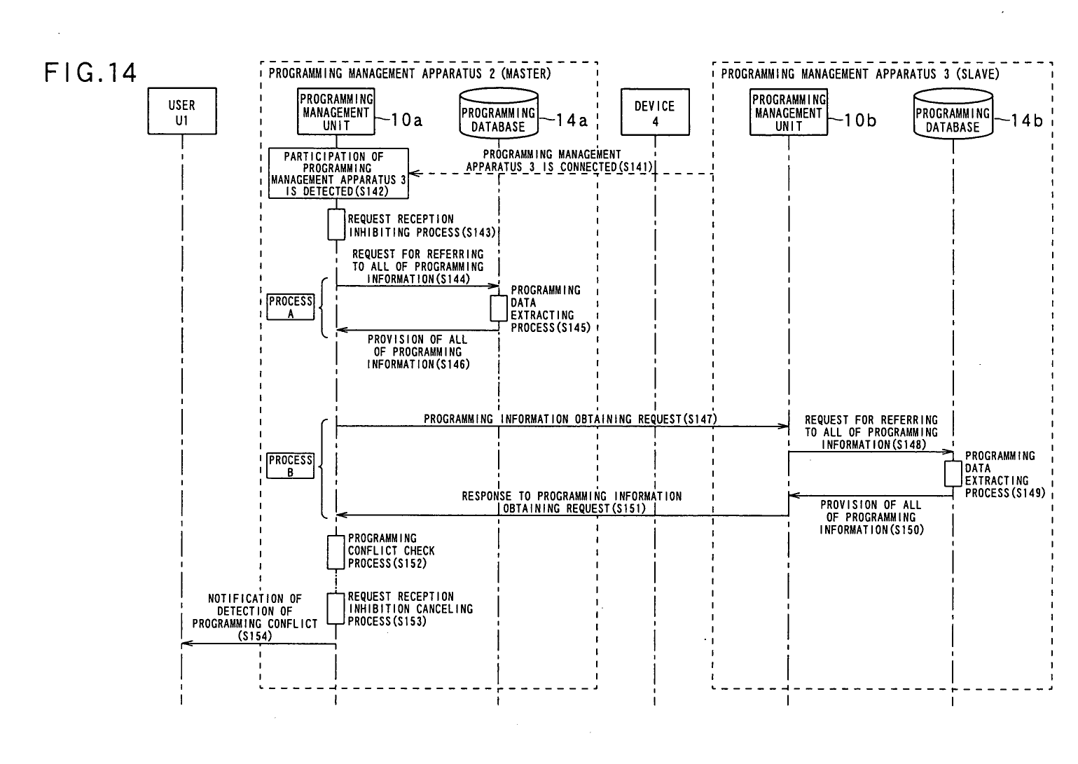

(1-1) FIG. 14 shows the flow of processes in a whole system when the programming management apparatus 2 as a master detects that the programming management apparatus 3 as a slave is connected via the network 1.

As shown in FIG. 14, first, when a programming management unit 10a in the programming management apparatus 2 detects participation of the programming management apparatus 3, the programming management unit 10a is set in a recording registering/updating request reception inhibiting state (steps S141 to S143).

Next, when the programming management unit 10a sends a recording information reference request to the programming database 14a in step S144, the programming database 14a executes a recording data extracting process (step S145) and provides the all the recording data to the programming management unit 10a (step S146). That is, the programming management unit 10a extracts all of recording data registered in the programming database 14a.

Subsequently, the programming management apparatus 2 transmits information indicative of a recording information obtaining request to the programming management apparatus 3 in step S147. When the programming management apparatus 3 which receives the information indicative of the recording information obtaining request sends a request for referring to all of recording information to the programming database 14b in step S148, the programming database 14b executes a recording data extracting process (step S149) and provides the all the recording data to the programming management unit 10b (step S150). That is, the programming management apparatus 3 extracts all of recording data registered in the programming database 14b held by itself, and transmits the data to the programming management apparatus 2 (step S151).

The programming management apparatus 2 which receives a response to the information indicative of the recording information obtaining request makes a recording conflict check by comparing the extracted recording information of the programming management apparatus 2 with the recording information of the programming management apparatus 3 (step S152). In the case where a conflict state is detected in the conflict check after the recording registering/updating request reception inhibiting state is canceled in step S153, the programming management unit 10a notifies the user U1 of the conflict state via the requesting/notifying unit 7a in the programming management apparatus 2 (step S154).

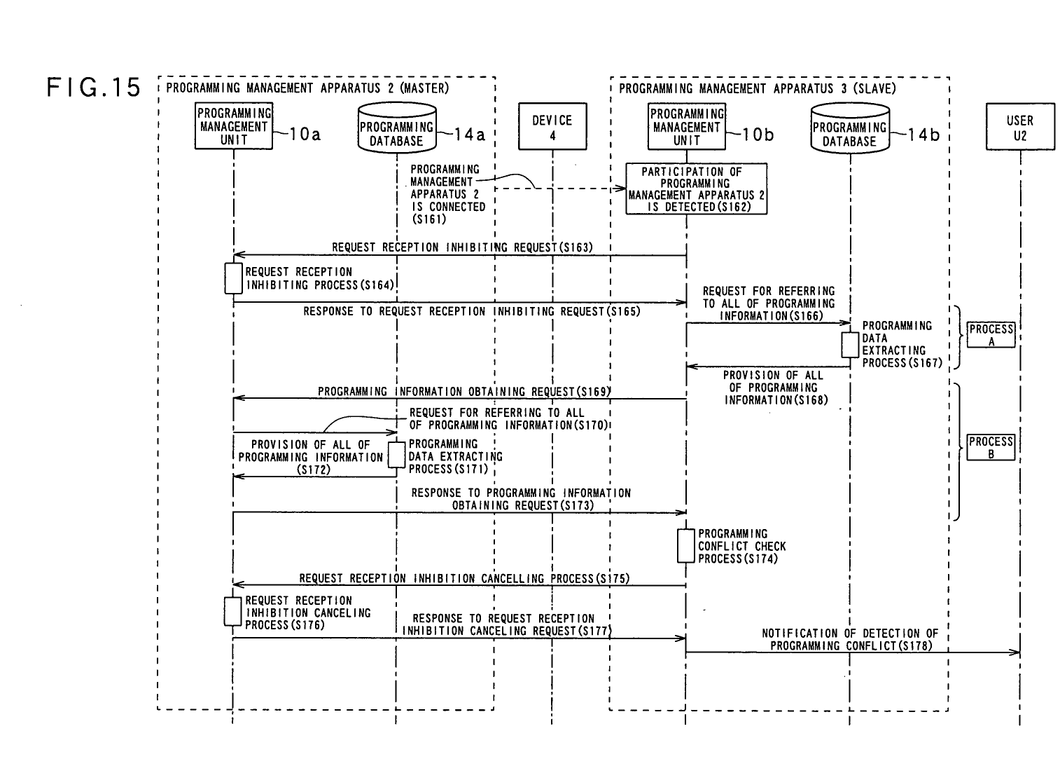

(1-2) FIG. 15 shows the flow of processes in a whole system when the programming management apparatus 3 as a slave detects that the programming management apparatus 2 as a master is connected via the network.

As shown in FIG. 15, first, when the programming management unit 10b in the programming management apparatus 3 detects participation of the programming management apparatus 2, the programming management unit 10b sends information indicative of a request for inhibiting reception of the recording registering/updating request to the programming management apparatus 2 as a master (steps S161 to S163).

The programming management apparatus 2 which receives the information indicative of the reception inhibition request sets a recording registering/updating request reception inhibiting state and, after that, sends a response to the programming management apparatus 3 (steps S164 and S165).

When the programming management apparatus 3 which receives the response to the reception inhibition request sends a request for referring to all of recording information to the programming database 14b in step S166, the programming database 14b executes a recording data extracting process (step S167) and, after that, provides all the recording information to the programming management unit 10b (step S168). That is, the programming management unit 10b extracts all of recording data registered in the programming database 14b.

Subsequently, the programming management apparatus 3 sends the information indicative of the recording information obtaining request to the programming management apparatus 2 in step S169. When the programming management apparatus 2 which receives the information indicative of the recording information obtaining request requests the programming database 14a to refer to all the recording information in step S170, the programming database 14a executes a recording data extracting process (step S171) and provides all the recording information to the programming management unit 10a (step S172). That is, the programming management apparatus 2 extracts all of the data registered in the programming database 14a held by itself, and transmits the data to the programming management apparatus 3 (step S173).

The programming management apparatus 3 which receives a response to the information indicative of the recording information obtaining request makes a recording conflict check by comparing the extracted recording information of the programming management apparatus 3 with the recording information of the programming management apparatus 2 (step S174). After that, the programming management unit 10b sends information indicative of a request for canceling the recording registering/updating request reception inhibition to the programming management apparatus 2 as a master in step S175.

The programming management apparatus 2 which receives information indicative of the reception inhibition cancel request cancels the recording registering/updating request reception inhibiting state in step S176 and, after that, sends back a response to the reception inhibition cancel request to the programming management apparatus 3 (step S177).

The programming management apparatus 3 receives the response and, after that, when a conflict state is detected in a conflict check, notifies the user U2 of occurrence of the conflict state via the requesting/notifying unit 7b in the programming management apparatus 3 (step S178).

In the embodiment, the performing order of the process of extracting recording information of an apparatus itself (process A) and the process of obtaining recording information from the other apparatus (process B) may be reversed in FIGS. 14 and 15.

According to the embodiment as described above, the conflict check is performed by the programming management apparatus itself. Consequently, the performing order of the process of obtaining recording information of an apparatus itself and the process of obtaining recording information of the other apparatus can be flexibly changed. For example, when recording information referring requests from the users are made at the same timing, a conflict occurs in accesses to the programming database 14a. In such a case, a countermeasure of obtaining the recording information from the other programming management apparatus first can be taken. In addition to the effects of the first embodiment, the effect of improved conflict detectability can be also obtained.

In the embodiment, in the case of sending a conflict notification to the user interface pre-mounted in a programming management apparatus, the conflict can be notified only when the user is near the programming management apparatus. If the conflict notification is not received by the user, the effect of the embodiment cannot be obtained. However, by pre-registering telephone number, facsimile number, or mail address of a notification destination of a conflict in a manner similar to the first embodiment, a conflict is notified by using a telephone/cellular phone, facsimile, or e-mail. In this case, the probability of notifying the user of the conflict can be improved dramatically, and the effects originally obtained can be produced more reliably.

The present invention is not limited to the foregoing embodiments but can be variously modified.

For example, although the case of using the network 1 conformed with the IEEE 1394 standard or the like as the network has been described in the foregoing embodiments, alternatively, an IP (Internet Protocol) network such as Ethernet (registered trademark) or wireless LAN (Local Area Network) may be used.

By recording a program corresponding to the flowcharts shown in FIGS. 4 to 15 in an information recording medium such as a flexible disk or HD (Hard Disk), or obtaining the program via a network such as the Internet and recording the program, and reading and executing the program by a general microcomputer or the like, the microcomputer can be made function as the programming management unit 10 or the like of the embodiment.

1. A programming management system in which a plurality of programming management apparatuses for managing programming information for programming an operation of a device and the device are connected to each other via a network, comprising:
a detecting device which detects that at least two programming management apparatuses are connected to each other via the network;
a requesting device which transmits the programming information registered in one of the programming management apparatuses, to the other programming management apparatus newly connected to the network, at the time of the detection, and requests check of a conflict;
a determining device by which the other programming management apparatus which receives a request of the check of the conflict checks conformity between the obtained programming information and the programming information which the other programming management apparatus itself retains, and determines the presence or absence of the conflict;
a responding device which responds the result thereof, to the requesting device which requests the check of the conflict; and
a notifying device, when occurrence of the conflict is detected, which notifies a user of the occurrence of the conflict.

2. A programming management system in which a device capable of registering programming information for programming an operation of the device and a programming management apparatus capable of managing the programming information registered in the device and registering the programming information are connected to each other via a network, comprising:
a detecting device which detects that the programming management apparatus and the device are connected to each other via the network;
a requesting device which transmits the programming information registered in the device newly connected to the network, to the programming management apparatus, at the time of the detection, and requests check of a conflict;
a determining device by which the programming management apparatus which receives a request of the check of the conflict checks conformity between the obtained programming information and the programming information which the programming management apparatus itself retains, and determines the presence or absence of the conflict;
a responding device which responds the result thereof, to the requesting device which requests the check of the conflict; and
a notifying device, when occurrence of the conflict is detected, which notifies a user of the occurrence of the conflict.

3. The programming management system according to claim 1,
wherein the notifying device is at least one of display means including image display and sound generation and communication means including a telephone, facsimile, and an e-mail.

4. A programming management apparatus connected, via a network, to a plurality of devices each capable of registering programming information for programming an operation of the device, and for managing the programming information, comprising:
a detecting device which detects connection of each of the devices via the network;
a determining device which checks conformity between the programming information registered in the device newly connected to the network, at the time of the detection, and the programming information which the programming management apparatus itself retains, and determines the presence or absence of the conflict;
a responding device which responds the result thereof, to a requesting device which requests the check of the conflict; and
a notifying device, when occurrence of the conflict is detected, which notifies a user of the occurrence of the conflict.

5. A programming management apparatus connected to a device via a network, and for managing programming information for programming an operation of the device, comprising:
a detecting device which detects connection to another programming management apparatus via the network;
a determining device which checks conformity between the programming information registered in the other programming management apparatus newly connected to the network, at the time of the detection, and the programming information which the programming management apparatus itself retains, and determines the presence or absence of the conflict;
a responding device which responds the result thereof, to a requesting device which requests the check of the conflict; and
a notifying device, when occurrence of the conflict is detected, which notifies a user of the occurrence of the conflict.

6. The programming management apparatus according to claim 4,
wherein the notifying device is at least one of display means including image display and sound generation and communication means including a telephone, a facsimile, and an e-mail.

7. A programming management method, in which a plurality of programming management apparatuses for managing programming information for programming an operation of a device and the device are connected to each other via a network, comprising:
a detecting process of detecting that at least two programming management apparatuses are connected to each other via the network;
a requesting process of transmitting the programming information registered in one of the programming management apparatuses, to the other programming management apparatus newly connected to the network, at the time of the detection, and requesting check of a conflict;
a determining process by which the other programming management apparatus which receives a request of the check of the conflict checks conformity between the obtained programming information and the programming information which the other programming management apparatus itself retains, and determines the presence or absence of the conflict;
a responding process of responding the result thereof, to the requesting process of requesting the check of the conflict; and
a notifying process of, when occurrence of the conflict is detected, notifying a user of the occurrence of the conflict.

8. A programming management method, in which a device capable of registering programming information for programming an operation of the device and a programming management apparatus capable of managing the programming information registered in the device and registering the programming information are connected to each other via a network, comprising:
a detecting process of detecting that the programming management apparatus and the device are connected to each other via the network;
a requesting process of transmitting the programming information registered in the device newly connected to the network, to the programming management apparatus, at the time of the detection, and requesting check of a conflict;
a determining process by which the programming management apparatus which receives a request of the check of the conflict checks conformity between the obtained programming information and the programming information which the programming management apparatus itself retains, and determines the presence or absence of the conflict;
a responding process of responding the result thereof, to the requesting process of requesting the check of the conflict; and
a notifying process of, when occurrence of the conflict is detected, notifying a user of the occurrence of the conflict.

9. A programming management method for managing programming information for programming an operation of a device, the programming information being able to be registered in a plurality of devices connected via a network, comprising:
a detecting process of detecting connection of each of the devices via the network;
a determining process of checking conformity between the programming information registered in the device newly connected to the network, at the time of the detection, and the programming information which the programming management apparatus itself retains, and determines the presence or absence of the conflict;
a responding process of responding the result thereof, to requesting process for requesting the check of the conflict; and
a notifying process of, when occurrence of the conflict is detected, notifying a user of the occurrence of the conflict.

10. A programming management method for managing programming information for programming an operation of a device connected via a network, comprising:
a detecting process of detecting connection to another programming management apparatus via the network;
a determining process of checking conformity between the programming information registered in the other programming management apparatus newly connected to the network, at the time of the detection, and the programming information which the programming management apparatus itself retains, and determines the presence or absence of the conflict;
a responding process of responding the result thereof, to requesting process for requesting the check of the conflict; and
a notifying process of, when occurrence of the conflict is detected, notifying a user of the occurrence of the conflict.

11. A recording medium in which a programming management program is computer-readably recorded, said programming management program making a computer included in a programming management system in which a plurality of programming apparatuses for managing programming information for programming an operation of a device and the device are connected to each other, function as:
a detecting device which detects that at least two programming management apparatuses are connected to each other via the network;
a requesting device which transmits the programming information registered in one of the programming management apparatuses, to the other programming management apparatus newly connected to the network, at the time of the detection, and requests check of a conflict;
a determining device by which the other programming management apparatus which receives a request of the check of the conflict checks conformity between the obtained programming information and the programming information which the other programming management apparatus itself retains, and determines the presence or absence of the conflict;
a responding device which responds the result thereof, to the requesting device which requests the check of the conflict; and
a notifying device, when occurrence of the conflict is detected, which notifies a user of the occurrence of the conflict.

12. A recording medium in which a programming management program is computer-readably recorded, said programming management program making a computer included in a programming management system in which a device capable of registering programming information for programming an operation of the device and a programming management apparatus capable of managing the programming information registered in the device and registering the programming information are connected to each other via a network, function as:
a detecting device which detects the programming management apparatus and the device are connected to each other via the network;
a requesting device which transmits the programming information registered in the device newly connected to the network, to the programming management apparatus, at the time of the detection, and requests check of a conflict;
a determining device by which the programming management apparatus which receives a request of the check of the conflict checks conformity between the obtained programming information and the programming information which the programming management apparatus itself retains, and determines the presence or absence of the conflict;
a responding device which responds the result thereof, to the requesting device which requests the check of the conflict; and
a notifying device, when occurrence of the conflict is detected, which notifies a user of the occurrence of the conflict.

13. A recording medium in which a programming management program is computer-readably recorded, said programming management program making a computer included in a programming management apparatus connected, via a network, to a plurality of devices each capable of registering programming information for programming an operation of the device, and for managing the programming information, function as:
a detecting device which detects connection of each of the devices via the network;
a determining device which checks conformity between the programming information registered in the device newly connected to the network, at the time of the detection, and the programming information which the programming management apparatus itself retains, and determines the presence or absence of the conflict;
a responding device which responds the result thereof, to a requesting device which requests the check of the conflict; and
a notifying device, when occurrence of the conflict is detected, which notifies a user of the occurrence of the conflict.

14. A recording medium in which a programming management program is computer-readably recorded, said programming management program making a computer included in a programming management apparatus connected to a device via a network, and for managing programming information for programming an operation of the device, function as:
a detecting device which detects connection to another programming management apparatus via the network;
a determining device which checks conformity between the programming information registered in the other programming management apparatus newly connected to the network, at the time of the detection, and the programming information which the programming management apparatus itself retains, and determines the presence or absence of the conflict;
a responding device which responds the result thereof, to a requesting device which requesting the check of the conflict; and
a notifying device, when occurrence of the conflict is detected, which notifies a user of the occurrence of the conflict.
